(19) United States
(12) Patent Application Publication
(10) Pub. No.: US 2025/0053631 A1
(43) Pub. Date: Feb. 13, 2025

(54) AUTHENTICATION DEVICE AND AUTHENTICATION METHOD

(71) Applicant: DENSO CORPORATION, Kariya-city (JP)

(72) Inventor: Nobuyasu OKABE, Kariya-city (JP)

(21) Appl. No.: 18/933,808

(22) Filed: Oct. 31, 2024

Related U.S. Application Data
(63) Continuation of application No. PCT/JP2023/018100, filed on May 15, 2023.

(30) Foreign Application Priority Data
May 31, 2022 (JP) 2022-088383

(51) Int. Cl. G06F 21/32; G06V 40/16

(52) U.S. Cl. CPC G06F 21/32; G06V 40/172

(57) ABSTRACT

An authentication device includes an authentication unit, an information acquisition unit, a companion identifying unit, a companion information identifying unit, and an authorization unit. The authentication unit authenticates a regular user who is authorized to use a specified component. The information acquisition unit acquires surrounding information around the specified component. The companion identifying unit determines whether the regular user is accompanied by a companion based on successful authentication of the regular user. The companion information identifying unit identifies companion information from the surrounding information. The authorization unit is configured to authorize the companion to use the specified component based on the companion information. The authentication unit further authenticates the companion who has been authorized by the authorization unit.

### CROSS REFERENCE TO RELATED APPLICATION

The present application is a continuation application of International Patent Application No. PCT/JP2023/018100 filed on May 15, 2023, which designated the U.S. and claims the benefit of priority from Japanese Patent Application No. 2022-088383 filed on May 31, 2022. The entire disclosures of all of the above applications are incorporated herein by reference.

### TECHNICAL FIELD

The present disclosure relates to an authentication device and an authentication method.

### BACKGROUND

A technique is known for authorizing unregistered users who are not registered as regular users to use a specified device.

### SUMMARY

An authentication device includes an authentication unit, an information acquisition unit, a companion identifying unit, a companion information identifying unit, and an authorization unit. The authentication unit is configured to authenticate a regular user who is authorized to use a specified component. The information acquisition unit is configured to acquire surrounding information around the specified component. The companion identifying unit is configured to determine whether the regular user is accompanied by a companion based on successful authentication of the regular user by the authentication unit. The companion information identifying unit is configured to identify companion information of the companion from the surrounding information acquired by the information acquisition unit based on the companion identifying unit having determined that the regular user is accompanied by the companion. The authorization unit is configured to authorize the companion to use the specified component based on the companion information identified by the companion information identifying unit. The authentication unit is further configured to authenticate the companion who has been authorized by the authorization unit.

An authentication method includes authenticating a regular user who is authorized to use a specified component, acquiring surrounding information around the specified component, determining whether the regular user is accompanied by a companion based on successful authentication of the regular user by the authentication unit, identifying companion information of the companion from the surrounding information based on determination that the regular user is accompanied by the companion, authorizing the companion to use the specified component based on the companion information, and authenticating the companion who has been authorized to use the specified component.

### BRIEF DESCRIPTION OF THE DRAWINGS

FIG. 1 is a diagram showing an example of a schematic configuration of an authentication system.

FIG. 2 is a diagram showing an example of a schematic configuration of a vehicle-side unit.

FIG. 3 is a diagram showing an example of a schematic configuration of an imaging-side control unit.

FIG. 4 is a diagram showing an example of a schematic configuration of a communication-side control unit.

FIG. 5 is a flowchart showing an example procedure of an authorization-related processing in the imaging-side control unit.

FIG. 6 is a flowchart showing an example procedure of the authorization-related processing in the communication-side control unit.

FIG. 7 is a flowchart showing an example procedure of post-grant related processing in the communication-side control unit.

FIG. 8 is a diagram showing an example of a schematic configuration of an imaging-side control unit.

FIG. 9 is a diagram showing an example of a schematic configuration of an authentication system.

FIG. 10 is a diagram showing an example of a schematic configuration of a facility-side unit.

FIG. 11 is a diagram showing an example of a schematic configuration of the imaging-side control unit.

FIG. 12 is a diagram showing an example schematic configuration of the communication side-control unit.

### DETAILED DESCRIPTION OF THE PREFERRED EMBODIMENTS

To begin with, examples of relevant techniques will be described.

A technique is known for authorizing unregistered users who are not registered as regular users to use a specified device. There is a technique for permitting a temporary user to drive with a temporary key based on operation inputs from the registered driver determined by a biometric authentication system.

In the technology, operation input by the registered driver is required to permit the temporary user to drive with the temporary key, which takes time for the registered driver. Here, in order to reduce the time for the registered driver, the temporary user may be automatically permitted to drive with a temporary key. However, when the temporary user is automatically permitted to drive with a temporary key, it is necessary not to grant permission to users who should not be authorized.

It is an objective of the present disclosure to provide an authentication device and authentication method that allow a user who is not registered as a regular user to be authorized to use a component while enhancing the security and convenience in authentication.

The above objective is achieved by the combination of features described in the independent claims, and the dependent claims define further advantageous specific examples of the disclosure.

In order to achieve the above objective, an authentication device of the present disclosure includes an authentication unit, an information acquisition unit, a companion identifying unit, a companion information identifying unit, and an authorization unit. The authentication unit is configured to authenticate a regular user who is authorized to use a specified component. The information acquisition unit is configured to acquire surrounding information around the specified component. The companion identifying unit is configured to determine whether the regular user is accompanied by a companion based on successful authentication of the regular user by the authentication unit. The companion information identifying unit is configured to identify companion information of the companion from the surrounding information acquired by the information acquisition unit based on the companion identifying unit having determined that the regular user is accompanied by the companion. The authorization unit is configured to authorize the companion to use the specified component based on the companion information identified by the companion information identifying unit. The authentication unit is further configured to authenticate the companion who has been authorized by the authorization unit.

To achieve the above objective, an authentication method of the present disclosure includes authenticating a regular user who is authorized to use a specified component, acquiring surrounding information around the specified component, determining whether the regular user is accompanied by a companion based on successful authentication of the regular user by the authentication unit, identifying companion information of the companion from the surrounding information based on determination that the regular user is accompanied by the companion, authorizing the companion to use the specified component based on the companion information, and authenticating the companion who has been authorized to use the specified component.

When authentication of the regular user is established and the companion is identified with the regular user, the companion is also authorized to use the specified component. The companion who has been authorized is authenticated from the next authentication. Thus, the companion is allowed to use the specified component without operations by the regular user to authorize the companion. In addition, the companion is allowed to use the specified component based on the companion information identified from the surrounding information around the specified component, thereby avoiding authorization to a user who should not be authorized. As a result, the security and convenience in authentication can be improved during authorization of unregistered users, who are not registered as regular users, to use the specified component.

Multiple embodiments will be described with reference to the accompanying drawings. For convenience of explanation, portions having the same functions as those illustrated in the drawings used in the description among embodiments are assigned the same reference numerals, and descriptions of the same portions may be omitted. Descriptions in another embodiment may be applied for the portions assigned the same reference numerals.

### First Embodiment

### <Schematic Configuration of an Authentication System 1

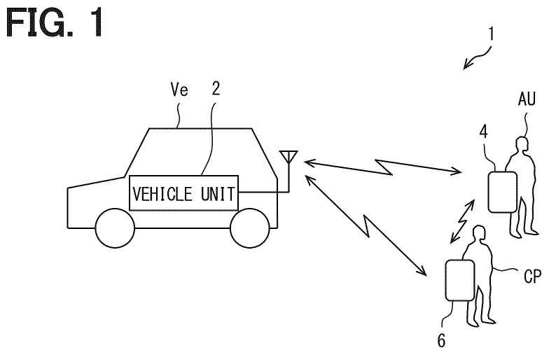

Hereinafter, a first embodiment of the present disclosure will be described with reference to the drawings. The authentication system 1 shown in FIG. 1 includes a vehicle-side unit 2, a mobile terminal 4, and a mobile terminal 6. The vehicle-side unit 2 is used in a vehicle Ve. In the example of the present embodiment, the vehicle Ve is, for example, an automobile. The vehicle Ve equipped with the vehicle-side unit 2 is not necessarily limited to an automobile.

The mobile terminal 4 is a communication terminal carried by a user. The mobile terminal 4 is carried by a regular user AU of the vehicle Ve. The regular user AU can be, for example, a manager of the vehicle Ve. The mobile terminal 4 may be a multifunction mobile phone such as a smartphone. The mobile terminal 4 performs wireless communication in accordance with the Bluetooth Low Energy standard (Bluetooth is a registered trademark). Hereafter, this wireless communication is referred to as BLE communication. In the BLE communication, the mobile terminal 4 wirelessly transmits a wireless signal including the source information at predetermined transmission intervals. As a result, the mobile terminal 4 advertises the existence of its own terminal. The wireless transmission is a broadcast communication. The BLE communication typically ranges from a few tens of meters up to 100 meters. Hereinafter, the wireless signal periodically transmitted for advertising is referred to as an advertising signal. The advertising signal can be referred to as information transmitted from the mobile terminal without user intervention. The source information is, for example, unique identification information (hereinafter, referred to as a terminal ID) assigned to the mobile terminal 4. In the BLE communication, pairing of devices, which is allowed by the user operation, enables unicast communication between the devices. The pairing is execution of a key exchange protocol.

The mobile terminal 6 is a communication terminal carried by a companion CP of the regular user AU. The mobile terminal 6 may be a multifunction mobile phone such as a smartphone. The mobile terminal 6 has similar functions as the mobile terminal 4. That is, the mobile terminal 6 also periodically transmits advertising signals.

The mobile terminal 4 preferably stores the period during which the mobile terminal 4 has continuously received the advertising signals transmitted successively from the mobile terminal 6. The period is hereafter referred to as an Adv receiving period. The Adv receiving period is stored in association with the terminal ID of the mobile terminal 6 included in the advertising signals. Then, the mobile terminal 4 transmits the Adv receiving period and the terminal ID of the mobile terminal 6 to the vehicle-side unit 2 when the unicast communication is performed between the mobile terminal 4 and the vehicle-side unit 2.

The vehicle-side unit 2 is used in the vehicle Ve as described above. Details of the vehicle-side unit 2 will be described below.

### <Schematic Configuration of the Vehicle-Side Unit 2>

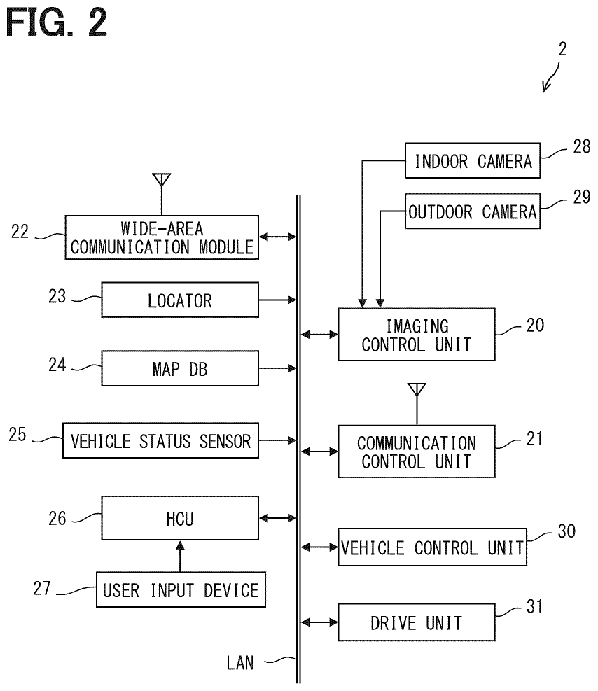

Next, a schematic configuration of the vehicle-side unit 2 is described with reference to FIG. 2. As shown in FIG. 2, the vehicle-side unit 2 includes an imaging-side control unit 20, a communication-side control unit 21, a wide area communication module 22, a locator 23, a map database (hereinafter referred to as DB) 24, a vehicle status sensor 25, a Human Machine Interface Control Unit (HCU) 26, a user input device 27, an indoor camera 28, an outdoor camera 29, a vehicle control unit 30, and a drive unit 31. For example, the imaging-side control unit 20, the communication-side control unit 21, the wide area communication module 22, the locator 23, the map DB 24, the vehicle status sensor 25, the HCU 26, the vehicle control unit 30, and the drive unit 31 are connected to a vehicle LAN (see LAN in FIG. 1). The indoor camera 28 and the outdoor camera 29 may also be connected to the LAN.

The wide area communication module 22 exchanges information with an external center outside the vehicle Ve via wireless communications. That is, the wide area communication module 22 performs wide area communications. The wide area communication module 22 receives information such as traffic congestion information from the external center through wide area communications.

The locator 23 includes a Global Navigation Satellite System (GNSS) receiver and an inertial sensor. The GNSS receiver is configured to receive positioning signals from multiple positioning satellites. The inertial sensor includes a gyro sensor and an acceleration sensor. The locator 23 sequentially measures a vehicle position of the vehicle Ve equipped with the locator 23 from a positioning signal received by the locator 23 and a measurement result from the inertial sensor. The vehicle position may be represented by, for example, coordinates of latitude and longitude.

The map DB 24 is a non-volatile memory and stores map data. The map data may be data, such as link data, node data, and road attributes. In addition, the map data may be distributed from a center, received by the wide area communication module 11, and stored in the map DB 24. In this case, the map DB 24 may be a volatile memory.

The vehicle status sensor 25 is a sensor group for detecting various status of the vehicle. Examples of the vehicle status sensor 25 include a vehicle speed sensor, a steering sensor, and a seating sensor. The vehicle speed sensor detects the traveling speed of the vehicle Ve. The steering sensor detects the steering angle of the vehicle Ve. The seating sensor detects the presence or absence of an occupant for each seat in the vehicle Ve. The seating sensor may be a pressure-sensitive sensor embedded in the seating surface of each seat. The vehicle status sensor 25 outputs detected sensing information to the in-vehicle LAN. The sensing information detected by the vehicle status sensor 25 may be output to the in-vehicle LAN through an ECU mounted on the vehicle Ve.

The HCU 26 performs various processes related to interaction between the system of the vehicle Ve and the occupants in the vehicle Ve. The HCU 26 performs various processes by executing control programs stored in the non-volatile memory. The HCU 26 receives inputs from the occupants in the vehicle Ve through a user input device 27.

The user input device 27 accepts input from the user. The user input device 27 functions as an input receiving device. The user here is the occupant in the vehicle Ve. The user input device 27 may be an operation device that receives operation inputs from the user. The operation device may be a mechanical switch, or may be a touch switch integrated with the display. Examples of the display include a meter Multi Information Display (MID) and Center Information Display (CID). The user input device 27 is not limited to the operation device that accepts operation inputs. The user input device 27 may be an audio input device that receives audio commands from the user.

The indoor camera 28 captures an image of the compartment of the vehicle Ve within a predetermined range. The predetermined range in the indoor camera 28 includes each seat of the vehicle Ve. The indoor camera 28 may be multiple indoor cameras 28. The indoor camera 28 includes, for example, a near-infrared light source and a near-infrared camera unit. The indoor camera 28 captures an image of the occupant using the near-infrared camera unit while illuminating the occupant with the near-infrared light using the near-infrared light source.

The outdoor camera 29 captures an area outside the compartment of the vehicle Ve within a predetermined range. The predetermined range in the outdoor camera 29 includes the vicinity of the door of the vehicle Ve. The door may be limited to, for example, the driver door. The door may be a passenger door and trunk door. The outdoor camera 29 may be multiple outdoor cameras 29. The outdoor camera 29 is equipped with, for example, a near-infrared light source and a near-infrared camera unit. The outdoor camera 21 captures an image of the occupant using the near-infrared camera unit while illuminating the occupant with the near-infrared light using the near-infrared light source. The outdoor camera 29 may be, for example, a color camera using a Charge Coupled Device (CCD).

The vehicle control unit 30 grants permission to use a component of the vehicle Ve. The component that requires permission to use is referred to as a target component or a specified component. The vehicle control unit 30 confirms authentication to the imaging-side control unit 20 and the communication-side control unit 21. Then, the vehicle control unit 30 grants permission to use the target component upon successful authentication in the imaging-side control unit 20 or the communication-side control unit 21. Examples of the target component include door lock motors and driving sources. The door lock motors and the driving sources correspond to components installed in the vehicle. Permission to use the door lock motor corresponds to permission to unlock the door. Permission to use the driving source corresponds to permission to start the driving source. The vehicle control unit 30 confirms authentication to the imaging-side control unit 20 and the communication-side control unit 21 when a predetermined trigger is detected.

The vehicle control unit 30 may confirm authentication to unlock the door when the vehicle control unit 30 detects an operation of a locking SW, for example. The locking SW is a switch for requesting locking or unlocking of the door of the vehicle Ve. The locking SW is provided, for example, on the outer door handles of the driver seat and passenger seat. The locking SW is provided on the rear bumper, for example, for the trunk door. The locking SW may be a touch switch or a mechanical button switch. The trigger for authentication confirmation to unlock the door may include operations other than the locking SW.

The vehicle control unit 30 may confirm authentication to start the driving source when the vehicle control unit 30 detects an operation of a start SW, for example. The start SW is a switch for requesting the start of the driving source of the vehicle Ve. The start SW is provided, for example, in front of the driver seat. The start SW may be a mechanical button switch.

The drive unit 31 operates the target component authorized for use by the vehicle control unit 30. The drive unit 31 is configured to unlock the door when unlocking is permitted. The drive unit 31 may output unlocking signals to the door lock motor to unlock the door. The drive unit 31 starts the driving source when the starting of the driving source is permitted. Examples of the driving source include internal combustion engines and motor generators.

The imaging-side control unit 20 includes, for example, a processor, a memory, I/O, and a bus connecting therebetween. The imaging-side control unit 20 executes various processes related to the authentication by executing control programs stored in the memory. The imaging-side control unit 20 authenticates the user based on the information obtained from the indoor camera 28 or the outdoor camera 29. The memory is a non-transitory tangible storage medium, which non-temporarily stores computer readable programs and data. Further, the non-transitory tangible storage medium is implemented by a semiconductor memory or the like. Details of the imaging-side control unit 20 will be described later.

The communication-side control unit 21 includes, for example, a processor, a memory, I/O, and a bus connecting therebetween. The communication-side control unit 21 executes various processes related to the authentication by executing control programs stored in the memory. The communication-side control unit 21 authenticates the user based on the information obtained from the mobile terminal 4 or the mobile terminal 6. The memory is a non-transitory tangible storage medium, which non-temporarily stores computer readable programs and data. Further, the non-transitory tangible storage medium is implemented by a semiconductor memory or the like. Details of the communication-side control unit 21 will be described later.

### <Schematic Configuration of the Imaging-Side Control Unit 20>

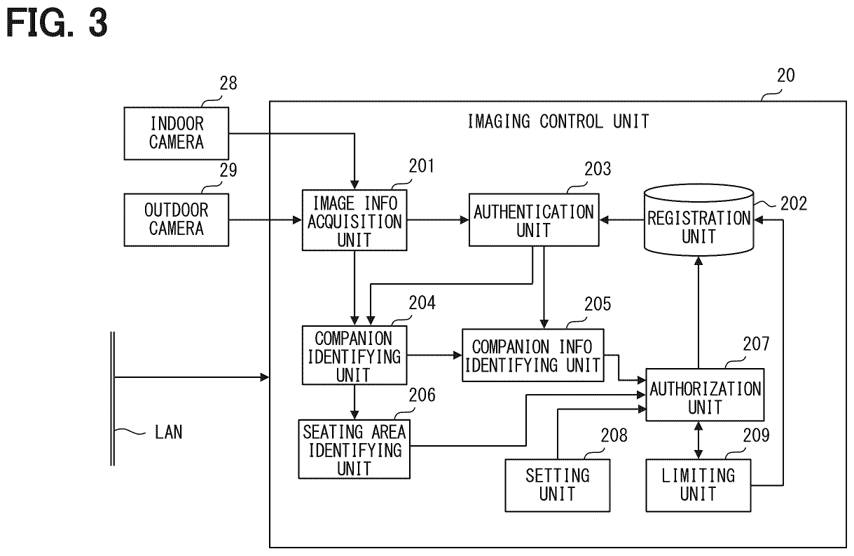

Next, the schematic configuration of the imaging-side control unit 20 is described with reference to FIG. 3. As shown in FIG. 3, the imaging-side control unit 20 includes, as functional blocks, an image information acquisition unit 201, a registration unit 202, an authentication unit 203, a companion identifying unit 204, a companion information identifying unit 205, a seating area identifying unit 206, an authorization unit 207, a setting unit 208, and a limiting unit 209. The imaging-side control unit 20 corresponds to an authentication device. Execution of a process of each functional block of the imaging-side control unit 20 by a computer corresponds to execution of an authentication method. Some or all of the functions executed by the imaging-side control unit 20 may be configured in hardware by one or multiple ICs or the like. In addition, some or all of the functional blocks included in the imaging-side control unit 20 may be implemented by a combination of software execution by the processor and hardware components.

The image information acquisition unit 201 acquires information obtained around the target component (hereinafter referred to as surrounding information). The image information acquisition unit 201 corresponds to an information acquisition unit. The process performed by the image information acquisition unit 201 corresponds to an information acquisition step. The image information acquisition unit 201 acquires images captured by the indoor camera 28 as the surrounding information. The image information acquisition unit 201 acquires images captured by the outdoor camera 29 as the surrounding information. Each of the indoor camera 28 and outdoor camera 29 corresponds to an imaging device. The image information acquisition unit 201 preferably acquires surrounding information sequentially. The image acquired by the image information acquisition unit 201 is hereinafter referred to as an acquired image.

The registration unit 202 includes in advance registered information of the regular user for authentication. The registration unit 202 may be a non-volatile memory. The regular user AU is a user that is allowed to use the target component. The information for authentication may be a facial feature of the regular user AU. The facial feature may be detected through facial image recognition technology.

The authentication unit 203 performs authentication. The process performed by the authentication unit 203 corresponds to an authentication step. The authentication unit 203 authenticates the regular user AU. The authentication unit 203 may perform authentication when the vehicle control unit 30 requests the authentication. The authentication unit 203 extracts facial image of a human from the acquired image. The authentication unit 203 detects facial features from the extracted facial image. The authentication unit 203 compares the detected facial features with the registered facial features of the regular user AU stored in the registration unit 202. The authentication unit 203 authenticates the regular user AU when the detected facial features in the acquired image match the facial features of the regular user AU in the registration unit 202. On the other hand, the authentication unit 203 does not authenticate the regular user AU when the detected facial features in the acquired images are different from the facial features of the regular user AU. The matching of facial features here can be defined as matching above a threshold. In other words, the authentication unit 203 performs facial authentication. The information for authentication may be a face image, not facial features. In this case, the authentication unit 203 may detect and compare the facial features from the face image.

The authentication unit 203 transmits the authentication result to the vehicle control unit 30. The vehicle control unit 30 confirms the authentication based on the result of the authentication transmitted from the authentication unit 203. The vehicle control unit 30 confirms the establishment of the authentication when receiving the result of the establishment of the authentication. On the other hand, the vehicle control unit 30 confirms that the authentication is not established when receiving the result that the authentication is not established. The vehicle control unit 30 permits the use of the target component when the vehicle control unit 30 has confirmed successful authentication. On the other hand, the vehicle control unit 30 does not permit the use of the target component when the vehicle control unit 30 has confirmed failure of the authentication. Note that the process of detecting facial features from face images may be performed by a control unit of the indoor camera 28 or the outdoor camera 29.

The companion identifying unit 204 determines whether the regular user AU is accompanied by a companion CP when the authentication unit 203 has authenticated the regular user AU. The processing at the companion identifying unit 204 corresponds to a companion identification step. The companion identifying unit 204 may determine that the regular user AU is accompanied by a companion when a face image that is different from the face image of the regular user AU is detected from the acquired image acquired by the image information acquisition unit 201. The face image different from the face image of the regular user AU may be a face image whose facial features do not match those of the regular user AU. The face image different from the face image of the regular user AU corresponds to the face image of the companion CP. The companion identifying unit 204 may determine that the regular user AU is accompanied by a companion when the seating sensor described above detects occupancy of two or more seats.

The companion information identifying unit 205 identifies companion information of the companion CP when the companion identifying unit 204 identifies the companion CP. The companion information identifying unit 205 identifies the companion information from the surrounding information acquired by the image information acquisition unit 201. The process executed by the companion information identifying unit 205 corresponds to a companion information identifying step. The companion information identifying unit 205 may identify, as the companion information, the face image different from the face image of the regular user recognized from the acquired image. The companion information identifying unit 205 preferably sequentially identifies the companion information from the sequentially acquired images.

The seating area identifying unit 206 identifies the seating area of the companion CP in the vehicle Ve when the companion identifying unit 204 identifies the companion CP. The seating area may be each seat. For example, when the seating sensor detects the occupancy of a specified seat different from the driver seat, the seating area of the companion CP may be the specified seat different from the driver seat. In addition, the seating area identifying unit 206 may identify the seating area of the companion CP from a position in the acquired image where the face image of the companion CP is recognized.

The authorization unit 207 authorizes the companion CP to use the target component based on the companion information identified by the companion information identifying unit 205. The process executed by the authorization unit 207 corresponds to an authorization step. As an example, the facial features of the companion CP are registered as authentication information in the registration unit 202. As for the companion CP whose facial features are registered in the registration unit 202, authentication will be established from the next authentication attempt. In other words, the authentication unit 203 authenticates the companion CP who has been authorized by the authorization unit 207 from the next authentication.

According to this, the companion CP can obtain authority to use the target component without operations by the regular user AU to authorize the companion CP. In addition, the companion CP is authorized to use the target component based on the companion information identified from the surrounding information which is obtained around the target component. Thus, it is possible to prevent a user who should not have access to the target component from obtaining authority. As a result, the security and convenience in authentication can be improved when unregistered users, who are not registered as regular users, are authorized to use the target component.

The authorization unit 207 preferably authorizes the companion CP to use the target component when the companion information identifying unit 205 has continuously identified the information of the identical companion CP for more than a predetermined period. The authorization unit 207 does not authorize the companion CP to use the target component when the companion information identifying unit 205 has not identified the information of the identical companion CP for the predetermined period. The predetermined period is arbitrarily set. For example, the predetermined period is five minutes. A user who is accompanied by the regular user in the same room for more than a certain period is presumed to have a trust relationship with the regular user AU. According to the above configuration, authority to use the target component is granted limited to a user who is assumed to have a trust relationship with the regular user AU. Thus, the security is further improved.

The authorization unit 207 preferably authorizes the companion CP to use the target component, limited to a designated seating area. In this case, the authorization unit 207 may register in the registration unit 202 the designated seating area for which the use of the target component is allowed in association with information for authentication of the companion CP. Hereinafter, the designated seating area where the use of the target component is allowed will be referred to as an authorized area. The authorized area may be preset by user setting through the user input device 27. Then, the authentication unit 203 preferably does not establish authentication when the seating area of the companion CP specified by the seating area identifying unit 206 is different from the authorized area. On the other hand, the authentication unit 203 may establish authentication when the seating area of the companion CP is the authorized area. According to this, the use of the target component for the companion CP is restricted depending on the seating area of the companion CP. For example, the authority to start the driving source is not given to the companion CP when the companion CP is seated on a seat other than the driver seat.

The setting unit 208 preferably sets the predetermined period according to inputs accepted by the user input device 27. According to this, the user can freely set the predetermined period.

The limiting unit 209 preferably sets a limit on the period during which the companion CP is authorized to use the target component. Hereinafter, this period is referred to as an authority granted period. The limiting unit 209 preferably revokes authority given to the companion CP to use the target component once a setting period has elapsed since the authority was granted for the companion CP. The period from when the authority is granted until the setting period elapses is referred to as the authority granted period. According to the above configuration, the user other than the regular user AU is temporarily allowed to use the target component. The authority granted period may be arbitrarily set. For example, the default authority granted period is 12 hours. The limiting unit 209 may determine the end of the authority granted period by a timer circuit or the like. The limiting unit 209 may delete the authentication information of the companion CP registered in the registration unit 202 when the authority granted period for the companion CP has expired.

The limiting unit 209 preferably revokes the authority of the companion CP to use the target component based on inputs accepted in the user input device 27. Hereinafter, the inputs that request revocation of authority are referred to as revocation request inputs. According to this, the authority of the companion CP to use the target component is revoked based on the request by the regular user AU.

The limiting unit 209 preferably extends the period during which the companion CP is authorized to use the target component each time the authentication unit 203 authenticates the regular user AU and the companion information identifying unit 205 identifies the information of the companion CP as identical to the information previously identified. In other words, the authority granted period is set to a longer value for the companion CP who often accompanies with the regular user AU when the regular user AU uses the target component. For example, a certain amount of time is added to the default authority granted period. Thus, the more frequently the companion CP accompanies the regular user AU, the less effort is required for reauthorization. The limiting unit 209 may store the authority granted period for the companion CP even after the authority granted period has expired and the companion CP has lost the authority. Then, the certain amount of time is added to the authority granted period for the companion CP every time the companion CP accompanies the regular user AU when the regular user AU uses the target component. The authority granted period may be stored in a non-volatile memory.

### <Schematic Configuration of the Communication-Side Control Unit 21>

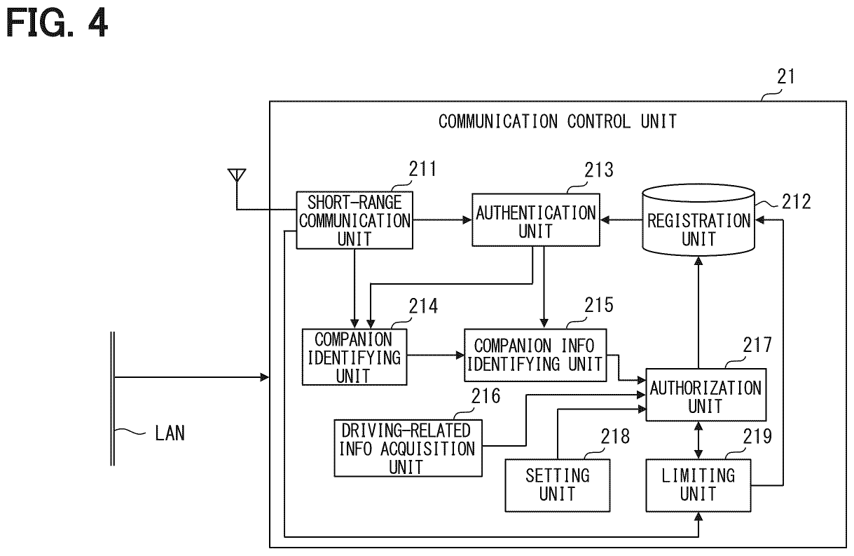

Next, a schematic configuration of the communication-side control unit 21 is described with reference to FIG. 4. As shown in FIG. 4, the communication-side control unit 21 has, as functional blocks, a short-range communication unit 211, a registration unit 212, an authentication unit 213, a companion identifying unit 214, a companion information identifying unit 215, a driving-related information acquisition unit 216, an authorization unit 217, a setting unit 218, and a limiting unit 219. The communication-side control unit 21 also corresponds to the authentication device. Execution of a process of each functional block in the communication-side control unit 21 by the computer also corresponds to execution of the authentication method. Some or all of the functions executed by the communication-side control unit 21 may be configured in hardware by one or multiple ICs or the like. In addition, some or all of the functional blocks included in the communication-side control unit 21 may be implemented by a combination of software execution by the processor and hardware components.

The short-range communication unit 211 performs wireless communication in accordance with the Bluetooth Low Energy standard via an antenna. The short-range communication unit 211 performs unicast communication with the mobile terminals 4, 6 once the pairing is performed. The short-range communication unit 211 acquires surrounding information around the target component. The short-range communication unit 211 corresponds to the information acquisition unit. The processing in the short-range communication unit 211 also corresponds to the information acquisition step. The short-range communication unit 211 acquires advertising signals transmitted sequentially from the mobile terminals 4, 6 as the surrounding information.

The registration unit 212 includes in advance registered information of the regular user AU for authentication. The registration unit 212 may be a non-volatile memory. The information for authentication may be the terminal ID of the mobile terminal 4 of the regular user AU.

The authentication unit 213 performs authentication. The process in the authentication unit 213 also corresponds to the authentication step. The authentication unit 213 authenticates the regular user AU. The authentication unit 213 performs authentication when the vehicle control unit 30 requests the authentication, like the authentication unit 203. The authentication unit 213 extracts the terminal ID from the advertising signals acquired by the short-range communication unit 211. The authentication unit 213 compares the extracted terminal ID with the terminal ID of the mobile terminal of the regular user AU registered in the registration unit 212. The authentication unit 213 establishes authentication when the detected terminal ID matches the terminal ID for the regular user AU. On the other hand, the authentication unit 213 does not establish authentication when the detected terminal ID is different from the terminal ID for the regular user AU. In other words, the authentication unit 213 performs ID authentication. The authentication unit 213 transmits the authentication result to the vehicle control unit 30. The vehicle control unit 30 confirms the authentication in the same way as the case based on the result of the authentication sent from the authentication unit 203. The vehicle control unit 30 confirms the establishment of the authentication when receiving the result of the establishment of the authentication.

The companion identifying unit 214 determines whether the regular user AU is accompanied by a companion CP when the authentication unit 213 has established the authentication of the regular user AU. The process in the companion identifying unit 214 also corresponds to the companion identifying step. The companion identifying unit 214 determines that the regular user AU is accompanied by the companion when the short-range communication unit 211 receives advertising signals including a terminal ID that is different from the mobile terminal of the regular user AU. The companion identifying unit 214 may also determine that the regular user AU is accompanied by a companion CP when the seating sensor described above detects occupancy of two or more seats.

The companion information identifying unit 215 identifies the companion information of the companion CP when the companion identifying unit 214 identifies the companion CP. The companion information identifying unit 215 identifies the companion information from the advertising signals acquired by the short-range communication unit 211. The process executed by the companion information identifying unit 215 corresponds to the companion information identifying step. The companion information identifying unit 215 may identify, as the companion information, the terminal ID included in the advertising signals that are acquired by the short-range communication unit 211 and different from the advertising signals of the mobile terminal of the regular user AU. Here, the advertising signals different from the advertising signals of the mobile terminal of the regular user AU is the advertising signals that do not include the terminal ID of the mobile terminal of the regular user AU. In other words, the advertising signals different from the advertising signals for the regular user AU are considered as the advertising signals for the companion CP. The companion information identifying unit 215 preferably sequentially identifies the terminal ID for the companion CP from the advertising signals obtained sequentially.

The driving-related information acquisition unit 216 acquires information about the driving status of the vehicle Ve (hereinafter referred to as driving-related information). The driving-related information includes traffic congestion information, for example. The driving-related information acquisition unit 216 may acquire traffic information via the wide area communication module 22. The driving-related information includes the speed of the vehicle Ve, for example. The driving-related information acquisition unit 216 may acquire the vehicle speed from the vehicle speed sensor described above. The driving-related information acquisition unit 216 includes the steering angle of the vehicle Ve, for example. The driving-related information acquisition unit 216 may acquire the steering angle from the steering sensor described above. The driving-related information includes the position of the vehicle Ve, for example. The driving-related information acquisition unit 216 may acquire the position of the vehicle Ve from the locator 23.

The authorization unit 217 also authorizes the companion CP to use the target component based on the companion information identified by the companion information identifying unit 215. The process in the authorization unit 217 corresponds to the authorization step. As an example, the terminal ID for the companion CP is registered as authentication information in the registration unit 212. The companion CP whose terminal ID is registered in the registration unit 212 can be authenticated from the next authentication. In other words, the authentication unit 213 establishes authentication for the companion CP having authorized by the authorization unit 217 from the next authentication. As a result, the security and convenience in authentication can be improved when unregistered users, who are not registered as regular users, are authorized to use the target component.

The authorization unit 217 preferably authorizes the companion CP to use the target companion based on the companion information identifying unit 215 having identified the identical advertising signals for the companion CP for the predetermined period. The process in the authorization unit 217 is the same as the authorization unit 207. According to this, the authority to use the target component is granted only to the user who is assumed to have a trust relationship with the regular user AU.

The authorization unit 217 preferably authorizes the companion CP to use the target component based on the companion information identifying unit 215 having identified the identical advertising signals for the companion CP for the predetermined period described above during the vehicle Ve driving at a speed equal to or more than a predetermined threshold speed. The short-range communication unit 211 can receive an advertising signal other than the advertising signal for the regular user AU and the advertising signal for the companion CP. Thus, even if the companion information identifying unit 215 has continuously identified the identical advertising signals for more than the predetermined period, the advertising signals may not the advertising signals for the companion CP. On the other hand, a user who is not riding in the vehicle Ve from obtaining the authority by identifying the companion information conditional on the vehicle speed Ve. Therefore, the security in authentication can be improved. The predetermined threshold speed may be a value to distinguish the predetermined threshold speed from the speed in traffic jam, for example. As an example, the predetermined threshold speed may be 20 km/h. The authorization unit 217 may determine whether the vehicle Ve is driving at a speed equal to or greater than the predetermined threshold speed using the driving-related information obtained by the driving-related information acquisition unit 216. In this case, the driving-related information includes the travelling speed of the vehicle Ve.

The authorization unit 217 preferably adds the condition that the vehicle Ve moves after having made right or left turns a predetermined number of times as one of the conditions for authorizing the companion CP to use the target component. The companion information identifying unit 215 is less likely to identify the advertising signals for a user who is not riding in the vehicle Ve for the predetermined period when the vehicle Ve makes right or left turns the predetermined number of times during the predetermined period. Thus, the configuration described above can prevent mistakenly granting authority to a user who is not riding in the vehicle Ve. Thus, security in authentication can be further improved.

The authorization unit 217 may, in the same manner as the authorization unit 207, grant the authority to use the target component to the companion CP, limited to the designated seating area in the vehicle Ve. The setting unit 218 preferably sets, in the same manner as the setting unit 208, the predetermined period described above based on the input accepted by the user input device 27. According to this, the user can freely set the predetermined period.

The limiting unit 219 preferably sets, in the same manner as the limiting unit 209, a limit on the period during which the companion CP is authorized to use the target component. The limiting unit 219 may delete authentication information of the companion CP which has been registered in the registration unit 212 when the authority granted period for the companion CP has expired.

The limiting unit 219 preferably revokes, in the same manner as the limiting unit 219, the authority for the companion CP to use the target component based on the revocation request input accepted by the user input device 27. According to this, the authority for the companion CP to use the target component is revoked based on the request by the regular user AU.

The limiting unit 219 preferably extends, in the same manner as the limiting unit 209, the period during which the companion CP is authorized to use the target component each time the authentication unit 213 authenticates the regular user AU and the companion information identifying unit 215 identifies the companion information as identical to the companion information previously identified.

The limiting unit 219 preferably extends the authority granted period for the companion CP temporarily when the pairing is performed between the mobile terminal 6 and the short-range communication unit 211. The pairing is caused by the operation of the mobile terminal 6. In other words, the pairing is caused by input from the companion CP. The temporary extension of the authority granted period refers to the temporary extension of the authority granted period for the companion CP who has been already authorized. In this context, the temporary extension refers to a limited extension between the grant of the authority and the revocation of the authority. According to this, the authority for the companion CP to use the target component can be temporarily extend based on the request of the companion CP.

The limiting unit 219 preferably extends the authority granted period for the companion CP temporarily when the short-range communication unit 211 receives the identification information of the companion CP from the mobile terminal 4 of the regular user AU. The identification information for the companion CP may be the Adv receiving period during which the mobile terminal 6 has received the identical advertising signals for the companion CP for equal to or more than a predetermined period. The predetermined period here can be arbitrarily set. For example, the predetermined period may be set to 5 minutes. For example, it is conceivable that the companion CP may return to the vehicle Ve separately from the regular user AU after both the companion CP and the regular user AU temporarily get off the vehicle Ve. Here, if the authority granted period for the companion CP has expired, convenience decreases. On the other hand, according to the above configuration, the authority granted period for the companion CP is temporarily extended, thereby improving convenience.

### <Authorization-Related Processing in the Imaging-Side Control Unit 20>

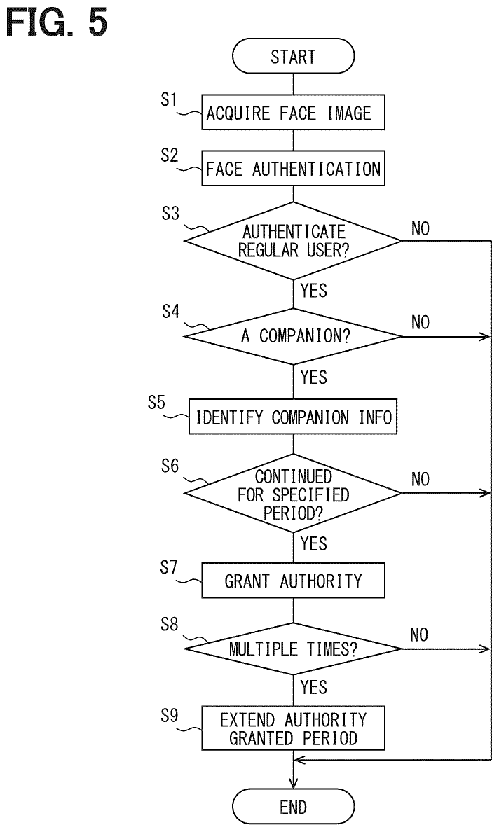

Next, an example of the procedure related to authorization for the companion CP to use the target component (hereinafter referred to as authorization-related processing) in the imaging-side control unit 20 will be explained with reference to the flowchart in FIG. 5. The flowchart in FIG. 5 may start when the vehicle control unit 30 makes an authentication request.

First, in step S1, the image information acquisition unit 201 acquires an image captured by the indoor camera 28 or the outdoor camera 29. In step S2, the authentication unit 203 performs face authentication using detected facial features from the image acquired in step S1.

In step S3, if the authentication of the regular user AU is successful (YES in S3), the process moves to step S4. On the other hand, if the authentication of the regular user AU is not completed (NO in S3), the authorization-related processing ends. The imaging-side control unit 20 replies to the vehicle control unit 30 about the result of authentication.

In step S4, the companion identifying unit 204 identifies the presence or absence of the companion CPU of the regular user AU. If the companion is identified (YES in S4), the process moves to step S5. On the other hand, if the companion is not identified (NO in S4), the authorization-related processing ends. In step S5, the companion information identifying unit 205 identifies, as the companion information, a face image that is recognized from the acquired image and differs from the face image of the regular user.

In step S6, if the companion information identifying unit 205 has continuously identified face images indicating the identical companion CP for a predetermined period or more (YES in S6), the process moves to step S7. On the other hand, if the face images of the identical companion CP have not been continuously identified for more than the predetermined period (NO in S6), the authorization-related processing ends. In step S7, authority to use the target component is granted to the companion CP who has been continuously identified from the face images for the predetermined period.

In step S8, if the authorized companion CP in step S7 has been authorized for multiple number of times in total (YES in S8), the process moves to step S9. On the other hand, if the companion CP has authorized for the first time in step S7 (YES in S8), the authorization-related processing ends. In step S9, the set value is added to the authority granted period for the authorized companion CP in step S7. Then, authorization-related processing ends.

### <Authorization-Related Processing in the Communication-Side Control Unit 21>

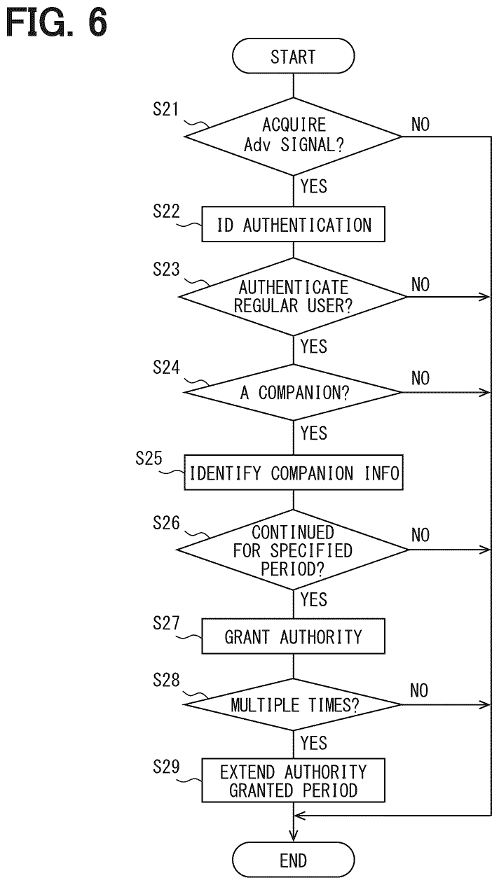

Next, an example of the procedure of the authorization-related processing in the communication-side control unit 21 will be explained with reference to the flowchart in FIG. 6. The flowchart in FIG. 6 may start when the vehicle control unit 30 makes an authentication request.

First, in step S21, If the short-range communication unit 211 acquires an advertising signal (YES in S21), the process moves to step S22. On the other hand, if the short-range communication unit 211 is unable to acquire an advertising signal (NO in S21), the authorization-related processing ends. As an example, the authorization-related processing ends when the short-range communication unit 211 fails to acquire an advertising signal within a set time after receiving the authentication request. In step S22, the authentication unit 213 performs ID authentication using the terminal ID included in the advertising signal acquired in step S21.

In step S23, if the authentication of the regular user AU is successful (YES in S23), the process moves to step S24. On the other hand, if the authentication of the regular user AU is not completed (NO in S23), the authorization-related processing ends. The communication-side control unit 21 replies to the vehicle control unit 30 about the result of the authentication.

In step S24, the companion identifying unit 214 identifies the presence or absence of the companion CP of the regular user AU. If the companion CP is identified (YES in S24), the process moves to step S25. On the other hand, if the companion CP is not identified (NO in S24), the authorization-related processing ends. In step S25, the companion information identifying unit 215 identifies, as the information of the companion CP, the terminal ID included in the advertising signal that is acquired by the short-range communication unit 211 and differs from the advertising signal for the regular user AU.

In step S26, if the companion information identifying unit 215 has identified the identical advertising signals for the companion CP for more than the predetermined period (YES in S26), the process moves to step S27. On the other hand, if the companion information identifying unit 215 fails to continuously identify the identical advertising signals for the companion CP for the predetermined period (NO in S26), the authorization-related processing ends. In step S27, the authority to use the target component is granted to the companion CP whose advertising signals can be identified continuously for the predetermined period.

In step S28, if the authorized companion CP in step S27 has been authorized for multiple number of times in total (YES in S28), the process moves to step S29. On the other hand, if the companion CP is authorized for the first time in step S27 (YES in S28), the authorization-related processing ends. In step S29, the set value is added to the authority granted period for the authorized companion CP in step S27. Then, authorization-related processing ends.

### <Post-Grant Related Processing in the Communication-Side Control Unit 21>

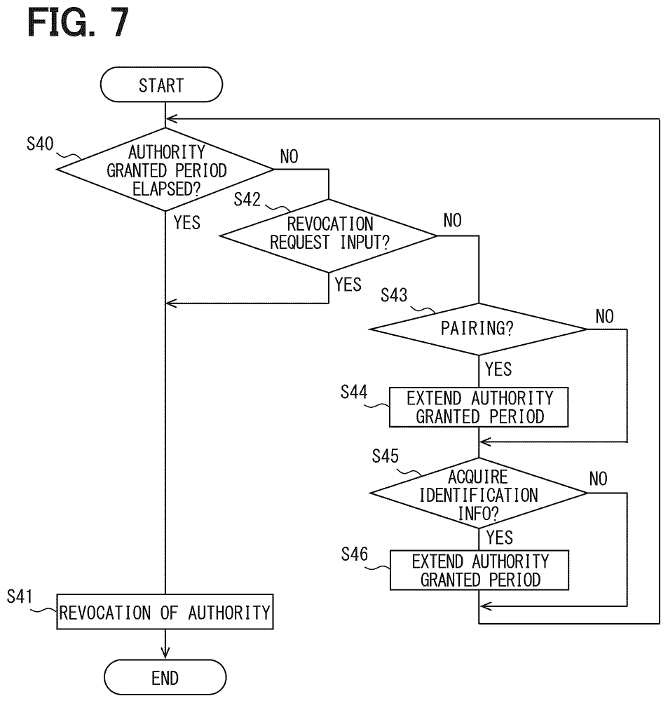

Next, an example of the procedure of processing in the communication-side control unit 21 after the companion CP has authorized (hereinafter, referred to as post-grant related processing) will be explained with reference to the flowchart in FIG. 7. The flowchart in FIG. 7 may start when the communication-side control unit 21 has authorized the companion CP to use the target component.

First, if the authority granted period has elapsed in step S40 (YES in S40), the process moves to step S41. On the other hand, if the authority granted period has not elapsed yet (NO in S40), the process moves to step S42. In step S41, the limiting unit 219 revokes the authority granted to the companion CP. Then, the post-grant related processing ends.

In step S42, if the user input device 27 accepts a revocation request input (YES in S42), the process proceeds to step S41. On the other hand, if the user input device 27 does not accept a revocation request input (NO in S42), the process proceeds to step S43. The limiting unit 219 may determine whether the user input device accepts a revocation request input.

In step S43, if a pairing is performed between the mobile terminal 6 of the companion CP and the short-range communication unit 211 (YES in S43), the process moves to step S44. On the other hand, if the pairing is not performed (NO in S43), the process moves to step S45. In step S44, the limiting unit 219 temporarily extends the authority granted period for the companion CP.

In step S45, when the short-range communication unit 211 acquires the identification information of the companion CP described above (YES in S45) from the mobile terminal 4 of the regular user AU, the process moves to step S46. On the other hand, when the identification information is not acquired (NO in S45), the process is back to step S40 and repeated. In step S46, the limiting unit 219 temporarily extends the authority granted period for the companion CP. Then, the process is returned to step S40 and repeated.

According to the first embodiment described above, the vehicle-side unit 2 includes both the imaging-side control unit 20 and the communication-side control unit 21. However, the present disclosure is not limited to this configuration. For example, the vehicle-side unit 2 may include either of the imaging-side control unit 20 or the communication-side control unit 21.

### Second Embodiment

The present disclosure is not limited to the configuration described in the first embodiment, and can also adopt the following configurations as a second embodiment. The following will describe an example of a configuration of the second embodiment with reference to the accompanying drawings. The authentication system 1 of the second embodiment is the same as the authentication system 1 of the second embodiment except that the authentication system 1 of the second embodiment includes an imaging-side control unit 20a instead of the imaging-side control unit 20 included in the vehicle-side unit 2.

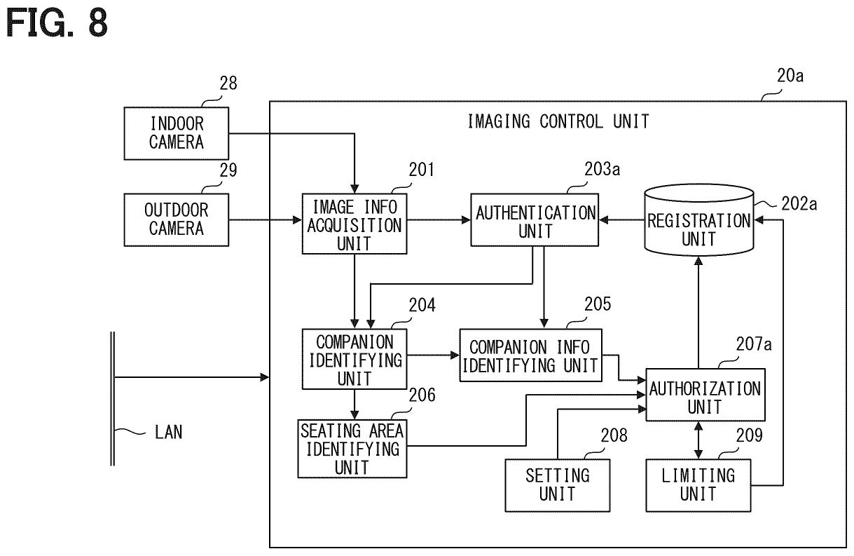

Here, the configuration of the imaging-side control unit 20a will be described with reference to FIG. 8. As shown in FIG. 8, the imaging-side control unit 20a includes, as functional blocks, the image information acquisition unit 201, a registration unit 202a, an authentication unit 203a, the companion identifying unit 204, the companion information identifying unit 205, the seating area identifying unit 206, an authorization unit 207a, the setting unit 208, and the limiting unit 209. The imaging-side control unit 20a is the same as the imaging-side control unit 20 of the first embodiment, except that the imaging-side control unit 20a includes the registration unit 202a, the authentication unit 203a, and the authorization unit 207a instead of the registration unit 202, the authentication unit 203, and the authorization unit 207. The imaging-side control unit 20a also corresponds to the authentication device. In addition, execution of the processing of each functional block in the imaging-side control unit 20a by the computer is also equivalent to the execution of the authentication method.

The authorization unit 207a is the same as the authorization unit 207 of the first embodiment except that the authorization unit 207a authorizes the companion CP to use different target components among multiple target components depending on the seating area in the vehicle Ve. As an example, both of authority for unlocking and authority to start the driving source may be granted for the occupant on the driver seat. On the other hand, authority for unlocking may be granted for the occupants on other seats different from the driver seat and authority to start the driving source may not be granted for the occupants on the other seats. The authorization unit 207a may register in the registration unit 202a at least one of the target components permitted for use in each seating area, linked to the authentication information of the companion CP. The registration unit 202a is the same as the registration unit 202 of the first embodiment, except for this point.

The authentication unit 203a authenticates the companion CP, who has been authorized by the authorization unit 207a, to use the at least one of the target components corresponding to the seating area of the companion CP at the time of authentication. The seating area identifying unit 206 may identify the seating area of the companion CP. According to this, the target components authorized for use can be restricted depending on the seating area of the companion CP.

### Third Embodiment

The present disclosure is not limited to the above-described embodiments, and may be configured as described in the third embodiment below. For example, a smart entry system can be used for authentication of the regular user AU. In this case, authentication of the regular user AU is performed by the smart entry system. On the other hand, authentication of the authorized companion CP will be performed as described in the embodiments described above.

### Fourth Embodiment

The present disclosure is not limited to the above-described embodiments, and may be configured as in the fourth embodiment below. The followings will describe a detailed example of the fourth embodiment with reference to the drawings.

<Schematic Configuration of an Authentication System 1b>

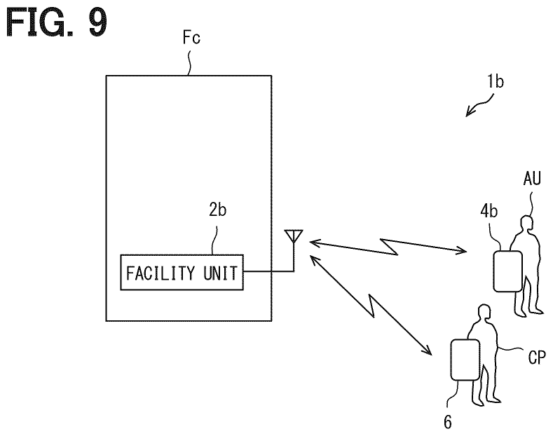

The authentication system 1b shown in FIG. 9 includes a facility-side unit 2b, a mobile terminal 4b, and a mobile terminal 6. The facility-side unit 2b is used in a facility Fc. The facility Fc may be, for example, the house of the regular user AU. Details of the facility-side unit 2b will be described later. The mobile terminal 4b is a communication terminal carried by the regular user AU. The mobile terminal 4b is the same as the mobile terminal 4 in the first embodiment except that the mobile terminal 4b does not store and transmit the Adv receiving period.

<Outline of the Facility-Side Unit 2b>

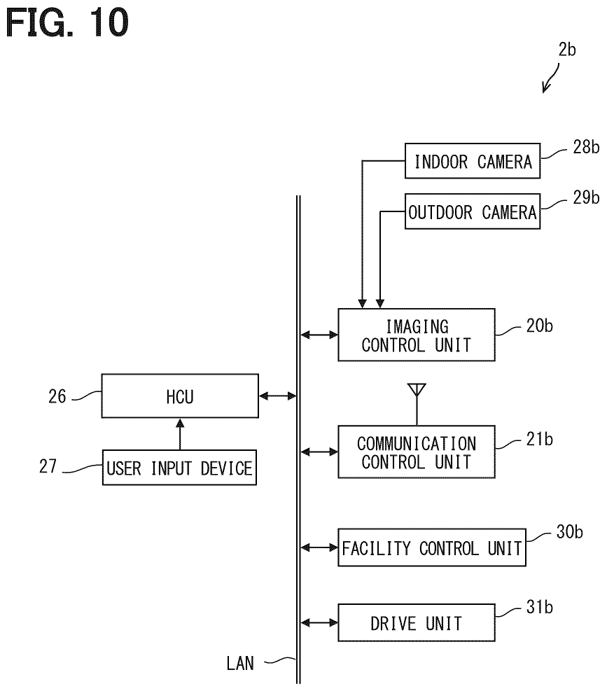

Next, the configuration of the facility-side unit 2b will be explained with reference to FIG. 10. As shown in FIG. 10, the facility-side unit 2b includes an imaging-side control unit 20b, a communication-side control unit 21b, the Human Machine Interface Control Unit (HCU) 26, the user input device 27, an indoor camera 28b, an outdoor camera 29b, a facility-side control unit 30b, and a drive unit 31b. For example, the imaging-side control unit 20b, the communication-side control unit 21b, the HCU 26b, the facility-side control unit 30b, and the drive unit 31b may be connected to the LAN. In addition, the indoor camera 28b and the outdoor camera 29b may also be connect to the LAN.

The HCU 26 executes various processes related to interactions between the system in the facility Fc and the user. The HCU 26 is the same as the HCU 26 in the first embodiment except that the HCU 26 is used in the facility Fc instead of the vehicle Ve.

The user input device 27 accepts input from the user. Here, the user is a user of the facility Fc. The user input device 27 is the same as the user input device 27 of the first embodiment, except that the input device 27 in the fourth embodiment is used in the facility Fc instead of the vehicle Ve.

The indoor camera 28b captures images of a predetermined area inside the facility Fc. The indoor camera 28b may be multiple. The indoor camera 28b may be, for example, a color camera. The indoor camera 28b may be equipped with, for example, a near-infrared light source and a near-infrared camera unit. The indoor camera 28b may be a camera attached to equipment used inside the facility Fc.

The outdoor camera 29b captures images of a predetermined range outside the facility Fc. The outdoor camera 29b may capture the surroundings of the facility Fc, including the area near the door of the facility Fc. The door may be limited to, for example, the front door. The outdoor camera 29b may be multiple. The outdoor camera 29b may be a color camera or a near-infrared camera.

The facility-side control unit 30b is configured to grant permission to use a component in the facility Fc. The component that requires permission to use is referred to as a target component. The facility-side control unit 30b confirms authentication with the imaging-side control unit 20b and the communication-side control unit 21b. Then, the facility-side control unit 30b grants permission to use the target component when the facility-side control unit 30b has confirmed that the authentication is successfully completed in the imaging-side control unit 20b or the communication-side control unit 21b. Examples of the target component include door lock motors. Permission to use the door lock motor corresponds to permission to unlock the door. The facility-side control unit 30b confirms authentication with the imaging-side control unit 20b and the communication-side control unit 21b when a predetermined trigger is detected.

The facility-side control unit 30b may confirm authentication to unlock the door when the operation of a locking switch (SW) is detected. The locking SW is a switch for requesting the locking/unlocking of the door of the facility Fc. The facility-side control unit 30b may use the detection of a person within a predetermined distance from the door of the facility Fc by an infrared sensor, as a trigger for authentication confirmation.

The drive unit 31b drives the target component authorized for use by the facility-side control unit 30b. The drive unit 31b unlocks the door when unlocking is permitted. The drive unit 31b may output unlocking signals to the door lock motor to unlock the door.

The imaging-side control unit 20b is similar to the imaging-side control unit 20 of the first embodiment, except for some differences in processing. The imaging-side control unit 20b performs user authentication based on information obtained from the indoor camera 28b or the outdoor camera 29b. The details of the imaging-side control unit 20b will be described later.

The communication-side control unit 21b is similar to the communication-side control unit 21 of the first embodiment, except for some differences in processing. The communication-side control unit 21b performs user authentication based on information obtained from the mobile terminal 4b or the mobile terminal 6. The details of the communication-side control unit 21b will be described later.

<Outline of the Imaging-Side Control Unit 20b>

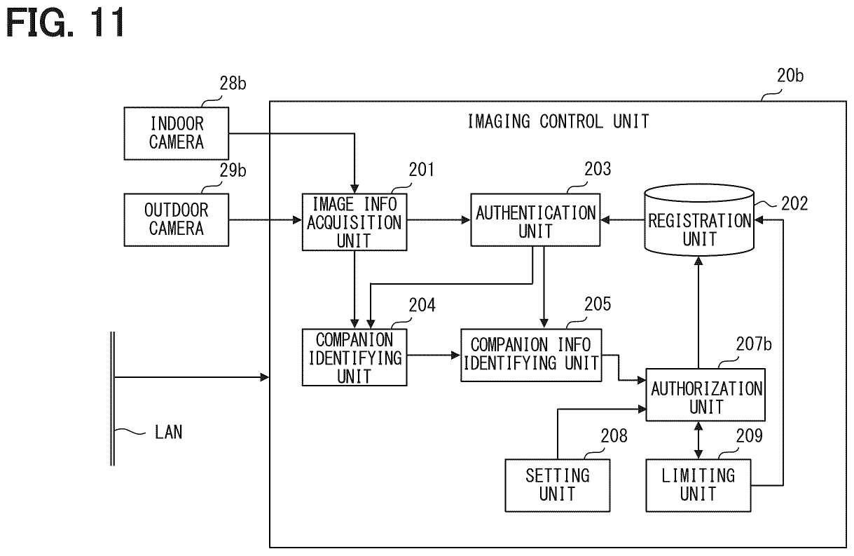

Next, the configuration of the imaging-side control unit 20b will be described with reference to FIG. 11. As shown in FIG. 11, the imaging-side control unit 20b includes, as functional blocks, the image information acquisition unit 201, the registration unit 202, the authentication unit 203, the companion identifying unit 204, the companion information identifying unit 205, an authorization unit 207b, a setting unit 208, and the limiting unit 209. The imaging-side control unit 20b differs from the imaging-side control unit 20 in that the imaging-side control unit 20b does not include the seating area identifying unit 206. The imaging-side control unit 20b differs from the imaging-side control unit 20 in that the imaging-side control unit 20b includes the authorization unit 207b instead of the authorization unit 207. The imaging-side control unit 20b is similar to the imaging-side control unit 20 except for the above points. The imaging-side control unit 20b also corresponds to the authentication device. In addition, execution of the processing of each functional block of the imaging-side control unit 20b by the computer is also equivalent to the execution of the authentication method.

The image information acquisition unit 201 acquires images from the indoor camera 28b and the outdoor camera 29b. The image information acquisition unit 201 is similar to the image information acquisition unit 201 of the first embodiment except for this point. Each of the indoor camera 28b and the outdoor camera 29b also corresponds to the imaging device.

The authentication unit 203 transmits the authentication result to the facility-side control unit 30b. The facility-side control unit 30b, in a manner similar to the vehicle-side control unit 30, performs authentication confirmation based on the authentication results transmitted from the authentication unit 203. The facility-side control unit 30b permits the use of the target component when authentication is confirmed.

The companion identifying unit 204 determines whether the regular user AU is accompanied by a companion CP when the authentication unit 203 has authenticated the regular user AU. The processing at the companion identifying unit 204 corresponds to the companion identifying step. The companion identifying unit 204 may determine that the regular user AU is accompanied by a companion CP when a face image different from the face image of the regular user AU is detected from the image acquired by the image information acquisition unit 201.

The authorization unit 207b is similar to the authorization unit 207 except that the authorization unit 207b does not perform processing using the seating area identified by the seating area identifying unit 206. The processing in the authorization unit 207b also corresponds to the authorization step.

<Outline of the Communication-Side Control Unit 21b>

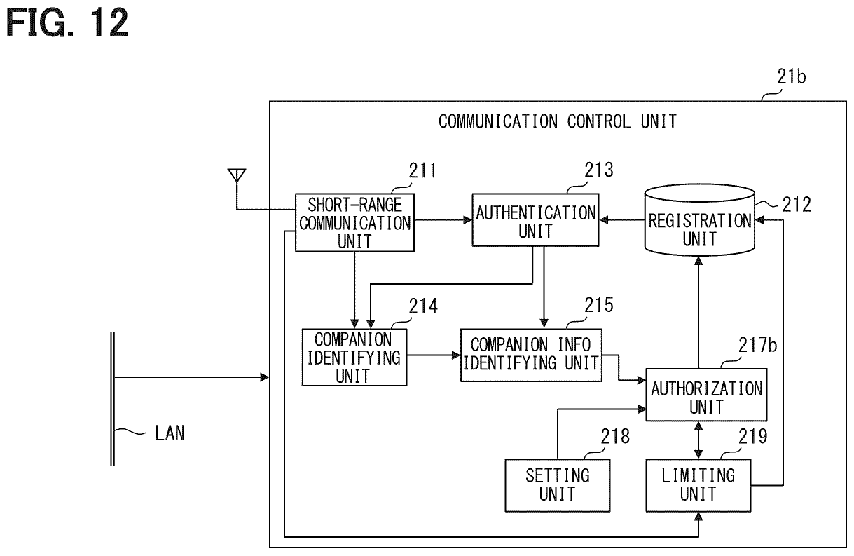

Next, the configuration of the communication-side control unit 21b will be described with reference to FIG. 12. As shown in FIG. 12, the communication-side control unit 21b includes, as functional blocks, the short-range communication unit 211, the registration unit 212, the authentication unit 213, the companion identifying unit 214, the companion information identifying unit 215, an authorization unit 217b, the setting unit 218, and the limiting unit 219. The communication-side control unit 21b differs from the communication-side control unit 21 in that the communication-side control unit 21b does not include the driving-related information acquisition unit 216. The communication-side control unit 21b differs from the communication-side control unit 21 in that the communication-side control unit 21b includes the authorization unit 207b instead of the authorization unit 207. The communication-side control unit 21b is similar to the communication-side control unit 21 except for the above points. The communication-side control unit 21b also corresponds to the authentication device. In addition, execution of the processing of each functional block of the communication-side control unit 21b by the computer is also equivalent to the execution of the authentication method.

The short-range communication unit 211 performs unicast communication with the paired mobile terminals 4b and 6. The short-range communication unit 211 acquires advertising signals sequentially transmitted from the mobile terminals 4b and 6. The short-range communication unit 211 is similar to the short-range communication unit 211 in the first embodiment except for these points.

The authentication unit 213 transmits the authentication result to the facility-side control unit 30b. The companion identifying unit 214 determines whether the regular user AU is accompanied by a companion CP when the authentication unit 213 has established the authentication of the regular user AU. The companion identifying unit 214 determines that the regular user AU is accompanied by the companion when the short-range communication unit 211 receives advertising signals including a terminal ID that is not for the mobile terminal of the regular user AU.

The authorization unit 217b is similar to the authorization unit 217 except that the authorization unit 217b does not use the driving-related information identified by the driving-related information acquisition unit 216. The processing in this authorization unit 217b also corresponds to the authorization step.

In the configuration of the fourth embodiment, the companion CP can obtain the authority to use the target component without operation by the regular user AU to allow the companion CP to use the target component. In addition, the companion CP is authorized to use the target component based on the companion information identified from the surrounding information obtained around the target component. Thus, it is possible to prevent a user who should not have access to the target component from obtaining authority. As a result, the security and convenience in authentication can be improved when unregistered users, who are not registered as regular users, are authorized to use the target component.

### Fifth Embodiment

In the embodiments described above, BLE communication is used as wireless communication between the short-range communication unit 211 and the mobile terminals 4, 4b, and 6. However, the present disclosure is not limited to this. For example, wireless communication conforming to the Bluetooth standard may be used. Also, other wireless communications may be used.

The present disclosure is not limited to the embodiments described above, and various modifications are possible within the scope of the claims. An embodiment obtained by appropriately combining technical means disclosed in different embodiments is also included within the technical scope of the present disclosure. The control device and the method of the control device described in the present disclosure may be implemented by a special-purpose computer which includes a processor programmed to execute one or more functions executed by computer programs. Also, the device and the method described in the present disclosure may be also realized by a special purpose hardware logic circuit. Alternatively, the device and the method described in the present disclosure may be implemented by one or more special-purpose computers configured by a combination of a processor executing a computer program and one or more hardware logic circuits. The computer program may be stored in a computer-readable non-transitory tangible storage medium as an instruction executed by a computer.

1. An authentication device comprising:
an authentication unit configured to authenticate a regular user who is authorized to use a specified component;
an information acquisition unit configured to acquire surrounding information around the specified component;
a companion identifying unit configured to determine whether the regular user is accompanied by a companion based on successful authentication of the regular user by the authentication unit;
a companion information identifying unit configured to identify companion information from the surrounding information acquired by the information acquisition unit based on the companion identifying unit having determined that the regular user is accompanied by the companion; and
an authorization unit configured to authorize the companion to use the specified component based on the companion information identified by the companion information identifying unit, wherein
the authentication unit is further configured to authenticate the companion who has been authorized by the authorization unit.

2. The authentication device according to claim 1, wherein
the information acquisition unit is configured to acquire, as the surrounding information, at least an image of surroundings of the specified component, the image being captured by an imaging device, and
the companion information identifying unit is configured to identify, as the companion information, a face image that is recognized from the image and differs from a face image of the regular user.

3. The authentication device according to claim 2, wherein
the information acquisition unit is configured to sequentially acquire the surrounding information,
the companion information identifying unit is configured to sequentially identify the companion information from the surrounding information sequentially acquired by the information acquisition unit, and
the authorization unit is configured to authorize the companion based on the companion information identifying unit having sequentially identified the companion information indicating the identical companion for a predetermined period.

4. The authentication device according to claim 2, wherein
the specified component is installed in a vehicle,
the authentication device further comprising
a seating area identifying unit configured to identify a seating area of the companion in the vehicle based on the companion identifying unit having determined that the regular user is accompanied by the companion, wherein
the authorization unit is further configured to authorize the companion to use the specified component based on the seating area of the companion corresponding to an authorized area in the vehicle, and
the authentication unit is further configured to not authenticate the companion based on the seating area of the companion identified by the seating area identifying unit being different from the authorized area.

5. The authentication device according to claim 2, wherein
the specified component is installed in a vehicle,
the specified component is one of multiple specified components,
the authentication device further comprising
a seating area identifying unit configured to identify a seating area of the companion in the vehicle, wherein
the authorization unit is further configured to authorize the companion to use different components among the multiple specified components for respective seating areas in the vehicle, and
the authentication unit is further configured to authenticate the companion to use at least one specified component among the multiple specified components according to the seating area identified by the seating area identifying unit.

6. The authentication device according to claim 1, wherein
the information acquisition unit is configured to acquire, as the surrounding information, advertising signals that are sequentially transmitted by a mobile terminal and indicate a presence of the mobile terminal, and
the companion information identifying unit is configured to identify, as the companion information, the advertising signals of the mobile terminal that are acquired by the information acquisition unit and different from advertising signals of a mobile terminal of the regular user.

7. The authentication device according to claim 6, wherein
the authorization unit is further configured to authorize the companion to use the specified component based on the companion information identifying unit having sequentially identified identical advertising signals for a predetermined period, the identical advertising signals being different from the advertising signals of the mobile terminal of the regular user.

8. The authentication device according to claim 7, wherein
the specified component is installed in a vehicle,
the authentication device further comprising
a driving-related information acquisition unit configured to acquire driving-related information that relates to a driving status of the vehicle, wherein
the authorization unit is further configured to authorize the companion to use the specified component based on the companion information identifying unit having sequentially identified the identical advertising signals for the predetermined period during the driving-related information indicating that the vehicle moves at a speed equal to or greater than a predetermined threshold speed.

9. The authentication device according to claim 8, wherein
the authorization unit is further configured to authorize the companion to use the specified component based on the companion information identifying unit having sequentially identified the identical advertising signals for the predetermined period during the driving-related information indicating that the vehicle moves at the speed equal to or greater than the predetermined threshold speed and has made right or left turns a predetermined number of times.

10. The authentication device according to claim 3, further comprising
a setting unit configured to set the predetermined period according to an input accepted by an input receiving device from a user.

11. The authentication device according to claim 1, further comprising
a limiting unit configured to set a limit on a period during which the companion is authorized to use the specified component.

12. The authentication device according to claim 11, wherein
the limiting unit is further configured to revoke authorization of the companion for use of the specified component based on an input accepted by an input receiving device from a user.

13. The authentication device according to claim 11, wherein
the limiting unit is configured to revoke authorization of the companion for use of the specified component based on a setting period having passed since a grant of the authorization for the companion.

14. The authentication device according to claim 13, wherein
the limiting unit is further configured to extend the setting period during which the companion is authorized to use the specified component each time the authentication unit authenticates the regular user and the companion information identifying unit identifies the companion information identical to the companion information previously identified.

15. The authentication device according to claim 13, wherein
the information acquisition unit is configured to acquire, as the surrounding information, at least advertising signals that are sequentially transmitted by a mobile terminal and indicate a presence of the mobile terminal,
the companion information identifying unit is configured to identify, as the companion information, the advertising signals of the mobile terminal that are acquired by the information acquisition unit and different from advertising signals of a mobile terminal of the regular user, and
the limiting unit is further configured to temporarily extend the setting period during which the companion is authorized to use the specified component based on a pairing being performed between the mobile terminal of the companion and the authentication device, the pairing being execution of a key exchange protocol caused by an input from the companion.

16. The authentication device according to claim 13, wherein
the information acquisition unit is configured to acquire, as the surrounding information, at least advertising signals that are sequentially transmitted by a mobile terminal and indicate a presence of the mobile terminal,
the companion information identifying unit is configured to identify, as the companion information, the advertising signals of the mobile terminal that are acquired by the information acquisition unit and different from advertising signals of a mobile terminal of the regular user,
the limiting unit is configured to temporarily extend the setting period during which the companion is authorized to use the specified component based on the information acquisition unit acquiring, from the mobile terminal of the regular user, information indicating that the mobile terminal of the regular user has sequentially received the advertising signals of the mobile terminal of the companion for a predetermined period. 17 An authentication method comprising:
authenticating a regular user who is authorized to use a specified component;
acquiring surrounding information around the specified component;
determining whether the regular user is accompanied by a companion based on successful authentication of the regular user;
identifying companion information from the surrounding information based on determination that the regular user is accompanied by the companion;
authorizing the companion to use the specified component based on the companion information; and
authenticating the companion who has been authorized to use the specified component.

18. An authentication device comprising:
at least one of (i) a circuit and (ii) a processor having a memory storing computer program code, wherein the at least one of the circuit and the processor having the memory is configured to cause the authentication device to:
authenticate a regular user who is authorized to use a specified component;
acquire surrounding information around the specified component;
determine whether the regular user is accompanied by a companion based on successful authentication of the regular user;
identify companion information from the surrounding information based on determination that the regular user is accompanied by the companion;
authorize the companion to use the specified component based on the companion information; and
authenticate the companion who has been authorized to use the specified component.
